(19) United States
(12) Patent Application Publication
(10) Pub. No.: US 2023/0302715 A1
(43) Pub. Date: Sep. 28, 2023

(54) APPARATUS AND METHOD FOR FORMING PLASTIC PREFORMS INTO PLASTIC CONTAINERS WITH VARIABLE PRESSURE STORAGE

(71) Applicant: KRONES AG, Neutraubling (DE)

(72) Inventors: Dominik MEIER, Parsberg (DE); Christian BETZ, Geigant (DE)

(21) Appl. No.: 18/124,816

(22) Filed: Mar. 22, 2023

(30) Foreign Application Priority Data
Mar. 22, 2022 (DE) 10 2022 106 703.3

(51) Int. Cl. B29C 49/78; B29C 49/58

(52) U.S. Cl. CPC B29C 49/783; B29C 49/58; B29C 49/36

(57) ABSTRACT

Apparatus for forming plastic preforms into plastic containers, having at least one forming station configured to form the plastic preforms into the plastic containers by the application of a flowable and, in particular, gaseous medium, wherein the forming station has an application device configured to apply on the plastic preforms with the flowable medium, and at least one first pressure reservoir configured to store the flowable medium at a predetermined pressure, wherein the apparatus has a pressure fluctuation reducing device which is configured for reducing pressure fluctuations in the first pressure reservoir.

### BACKGROUND OF THE INVENTION

The present invention relates to an apparatus and a method for forming plastic preforms into plastic containers. Such apparatus and methods have been known in the prior art for a long time. Usually, plastic preforms are fed into blow moulds and a flowable medium, in particular compressed air, but sometimes also liquid, is applied to them and they are formed into plastic containers and in particular plastic bottles.

Usually, compressed air is supplied from a reservoir such as a compressor to a pressure storage or pressure reservoir. This pressure reservoir then supplies a plurality of forming stations with the desired air pressure. Often, several such compressed air reservoirs are available for several different pressure levels.

The blow moulding process for stretch blow moulding of plastic containers is currently designed with at least two pressure stages. In most cases, even three pressure stages are used in order to recycle part of the compressed air used in the blow moulding process. The pressure of the lowest pressure stage P1 is currently in the range of 10 bar-13 bar. The highest pressure stage P2 is between 22 bar and 40 bar. An intermediate pressure stage (often referred to as PI) lies between the first-mentioned pressures.

The choice of pressure level depends on the container and the recycling potential. In order to be able to achieve even greater air savings in the future, an additional intermediate blowing stage is sometimes used. This is marked P+ in the following. Recycling in the blow-moulding machine takes place in the following way.

Starting from the bottle filled with P2 (i.e. the highest pressure), recycling takes place in the pressure stages PI and P+ until the ring channels of the individual pressure stages are filled. This is followed by recycling in P1. After P1 recycling, the residual volume in the bottle is relieved against the environment. In order to be able to recycle as much air volume as possible, there is a clear objective that the P1 pressure should be reduced to a low level.

Bottle quality depends to a considerable extent on the P1 pressure, i.e. the lowest pressure. This is because the segment weight distribution is determined during the P1 phase. Disturbance variables here are above all pressure fluctuations in the P1 channel or the P1 reservoir, which impair the robustness of the process and lead to reject containers. It has been proven that this problem becomes increasingly worse the lower the P1 pressure level becomes. The serious consequence of this is an increased number of faulty containers with the consequence that savings potential is not exploited due to this issue.

### SUMMARY OF THE INVENTION

An apparatus according to the invention for forming plastic preforms into plastic containers has at least one forming station which forms and in particular expands the plastic preforms into the plastic containers by applying a flowable and in particular gaseous medium. The forming station has an application device which applies the plastic preforms with the flowable medium, as well as at least one first pressure reservoir which stores the flowable medium at a predetermined pressure.

According to the invention, the apparatus comprises a pressure fluctuation reducing device which is suitable and intended to reduce pressure fluctuations in the first pressure reservoir.

Preferably, the apparatus is a blow moulding machine and in particular a stretch blow moulding machine. Particularly preferably, the apparatus comprises several such forming stations. Preferably, these forming stations are arranged on a movable and in particular on a rotatable carrier.

Preferably, the at least one pressure reservoir is designed as an annular channel and is preferably also arranged on the movable and in particular rotatable carrier.

In a preferred embodiment, the application device has a blow nozzle which can be placed against a mouth of the plastic preforms in order to expand them with the flowable medium, in particular compressed air. This application device can preferably be brought into a flow connection with the pressure reservoir, in particular by means of a valve device.

Preferably, the forming station has a stretching bar. Particularly preferably, the forming station has a blow mould that can be opened and closed.

As mentioned, the core of the present invention is to compensate for pressure fluctuations in the reservoir. The phenomenon of interference, i.e. the superposition of waves, is known from physics. If two waves with the same frequency are superimposed, the waves add up differently depending on their phase shift. At a certain place and at a certain time, it can therefore happen that the deflection of the resulting wave increases or decreases.

The pressure curve in the reservoir, for example the annular channel, can be represented over time by a (particularly sinusoidal) wave. If this wave is superimposed by a wave generated by a pressure fluctuation absorber or pressure fluctuation reducer, whose deflection is exactly opposite at the point in time under consideration, the original wave is cancelled or considerably reduced in amplitude due to destructive interference.

The pressure fluctuation reduction device or the pressure fluctuation damper can be similar in its construction to a loudspeaker, for example. Thus, via movements of a diaphragm or a piston, corresponding waves are induced in the compressed air system or the compressed air reservoir, which are the result of any effects such as valve opening and closing or other disturbance variables. One approach would be to measure the pressure waves in the reservoir. Preferably, a processor device and/or logic calculates the frequency amplitude and phase of the wave induced by the vibration damper, which is then generated by the vibration damper and superimposed on the wave in the annular channel in such a way that the pressure fluctuations are minimised or cancelled out.

In a preferred embodiment, two or more pressure fluctuation reduction devices are provided, which are assigned to the pressure reservoir. If the pressure reservoir is designed as an annular channel, for example, several pressure fluctuation reduction devices can be provided on this annular channel distributed over its circumference, for example two, three or also several pressure fluctuation reduction devices. It would be possible and preferred that these pressure fluctuation reduction devices are controlled jointly.

A further possibility is to compensate for the pressure increase by briefly increasing the volume of the reservoir. The idea here is to briefly increase the volume in the reservoir in the event of a pressure increase in such a way that the pressure increase is cushioned. The increase in volume can be achieved, for example, by a displaceable element which is controlled by a drive such as a servomotor. Assuming a reservoir volume of 2 l and a P1 pressure of 6 bar, the volume could be increased by 0.33 l in an adiabatic system and a short-term pressure increase of 1 bar.

By reducing the pressure fluctuations or cancelling them out, a reproducible container quality with high robustness can be ensured even at low P1 pressures of 4 bar-6 bar. This means that the recycling potential of the machine can be increased. This means lower air consumption and thus lower operating costs and for the machine an increase in machine efficiency and a saving of resources, which additionally increases the environmental friendliness of the machine.

In a further advantageous embodiment, the apparatus comprises a second pressure reservoir which stores the flowable medium under a second predetermined pressure.

Advantageously, the flowable medium is a gaseous medium and in particular compressed air. Particularly preferably, this second predetermined pressure is different or differs from the first pressure and is in particular greater than the first pressure.

Preferably, the apparatus has a third pressure reservoir and preferably also a fourth pressure reservoir.

In a further advantageous embodiment, the apparatus has a valve unit which is suitable for applying different pressure levels of the flowable medium to the plastic preforms, wherein this valve unit being associated in particular with the forming station. Particularly preferably, the valve unit is a valve block. Particularly preferably, this valve unit has at least two, preferably has at least two and preferably has at least two valves.

Preferably, the application device can be brought into flow connection via these valves with the at least one and preferably with several pressure reservoirs, so that compressed air can reach the application device from these pressure reservoirs.

In a further advantageous embodiment, an intake volume of the first pressure reservoir can be changed. Through this volume change, pressure fluctuations can be compensated as mentioned above.

In a preferred embodiment, the apparatus has a volume changing device (and/or the pressure fluctuation reducing device is designed as a volume changing device which is suitable and intended to change a receiving volume of the first pressure reservoir. Furthermore, it would also be possible for further pressure reservoirs to be assigned such volume changing devices. In particular, this volume changing device (which preferably also acts as a pressure fluctuation reduction device in this way) is suitable and intended for changing the intake volume of the reservoir by at least 5%, preferably by at least 10%, preferably by at least 15%, preferably by at least 20% and preferably by at least 25%.

Preferably, the intake volume of the reservoir or reservoirs may be changed by at most 60%, preferably by at most 50%, preferably by at most 40% and preferably by at most 35%.

In a preferred embodiment, the pressure fluctuation reducing device and/or the volume changing device comprises a diaphragm and/or a movable piston element.

In a preferred embodiment, the volume changing device has a movement-generating device and, in particular, an electrically and/or electromagnetically operated movement-generating device, wherein the movement-generating device being designed, in particular, as a vibration-generating device. In this case, for example, the volume changing device can be designed in the manner of a loudspeaker, which can apply volume fluctuations with a predetermined frequency to the reservoir.

In a further advantageous embodiment, the apparatus has at least one sensor device which is suitable and intended for detecting pressures and, in particular, pressure fluctuations within the reservoir. With the help of this sensor device, the pressure fluctuation reduction device can be controlled.

In a preferred embodiment, the apparatus has at least two and preferably at least three such sensor devices. These sensor devices can be arranged, for example, within the reservoir, which is designed in particular as an annular channel. In this way, (also local) pressure fluctuations can be detected with high accuracy.

Preferably, therefore, the apparatus comprises a control device which controls the volume of the reservoir in dependence on the pressure values detected by the sensor device. For example, it is possible for logic to calculate a frequency amplitude and/or phase of the wave induced by a vibration damper or the vibration reduction device, which is then generated by the latter to superimpose the wave in the reservoir in such a way that the pressure fluctuations are minimised and preferably cancelled.

In a further preferred embodiment, the apparatus comprises a heating device which heats the plastic preforms before they are fed to the forming stations.

The present invention is further directed to a method for forming plastic preforms into plastic containers, wherein with at least one forming station, the plastic preforms are formed into the plastic containers by the application of a flowable and, in particular, gaseous medium, and wherein the forming station comprises an application device which applies on the plastic preforms with the flowable medium, and a first pressure reservoir which stores the flowable medium under a predetermined pressure.

According to the invention, the apparatus comprises a pressure fluctuation reducing device which reduces pressure fluctuations in the first pressure reservoir.

In a preferred method, the containers are applied with at least two and preferably several pressures and/or pressure stages. Advantageously, the containers are applied with at least two, preferably at least three different pressures and/or pressure stages. Advantageously, the above-mentioned pressure fluctuations are reduced in particular at the lowest and/or generally the lowest pressure stages.

In a preferred method, said pressure reservoir contains a pressure of more than two bar, preferably more than three bar, preferably more than four bar. In a further preferred method, the pressure reservoir contains a pressure of less than 20 bar, preferably less than 15 bar, preferably less than 12 bar and preferably less than 10 bar.

In a preferred method, pressure fluctuations in the first pressure reservoir are changed and/or reduced by a change in volume of the first pressure reservoir. Preferably, these volume changes occur periodically.

In a further preferred method, at least one sensor device records or determines pressures and, in particular, pressure fluctuations within a reservoir, wherein, in particular, frequencies and/or amplitudes of these pressure fluctuations are determined. Based on these measurement results, the pressure fluctuations can be reduced.

In a further preferred method, a volume of the reservoir is changed periodically at least from time to time. This periodic change can also counteract pressure fluctuations.

In a further preferred method, the intake volume of the reservoir is changed depending on the pressures detected by the sensor device.

### BRIEF DESCRIPTION OF THE DRAWINGS

Further advantages and embodiments can be seen in the attached drawings:

In the drawings:

FIG. 1 shows a representation of an apparatus according to the invention for forming plastic preforms into plastic containers;

FIG. 2 shows a representation of pressure fluctuations in a reservoir;

FIG. 3 shows a first schematic representation of a pressure fluctuation reduction device;

FIG. 4 shows a second illustration of a pressure fluctuation reducing device; and

FIG. 5 shows a further illustration of a pressure fluctuation reduction device.

### DETAILED DESCRIPTION OF THE DRAWINGS

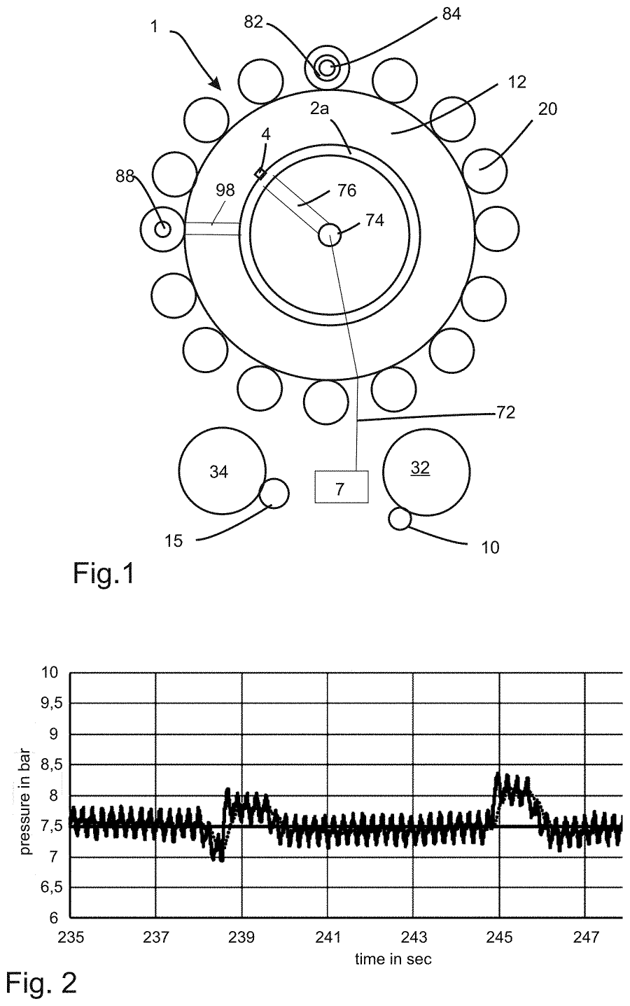

FIG. 1 shows an apparatus 1 for forming plastic preforms 10 into plastic containers 15. This apparatus has a rotatable carrier 12 on which a plurality of forming stations 20 are arranged. These individual forming stations each have blow moulds 82 which form a cavity 84 in their interior for expanding the plastic preforms. The reference sign 88 indicates a stretching bar which serves to stretch the plastic preforms in their longitudinal direction. Preferably, all the forming stations comprise such blow moulds 82 and stretching bars 88. Preferably, the number of these forming stations is between 2 and 100, preferably between 4 and 60, preferably between 6 and 40.

The plastic preforms 10 are fed to the apparatus via a first transport device 32, such as in particular but not exclusively a transport starwheel. The plastic containers 15 are transported away via a second transport device 34.

The reference sign 7 indicates a pressure supply device such as a compressor or also a compressed air connection. The compressed air is conveyed via a connection line 72 to a rotary distributor 74 and from there via a further line 76 to the reservoir 2a, which in this case is an annular channel.

In addition to this ring channel 2a shown, further ring channels are preferably provided, but in the illustration shown in FIG. 1 they are covered by the ring channel 2a, for example they are located below it. The reference sign 98 indicates a connection line which delivers the compressed air to a forming station 20. Preferably, each of the ring channels is connected to all forming stations via corresponding connecting lines.

FIG. 2 shows the pressure fluctuations in the reservoir 2a, i.e. the annular channel 2a over time. You can see periodic pressure fluctuations that occur here in a time span of 12 seconds. These pressure fluctuations have a negative effect especially at low pressures such as the P1 pressure.

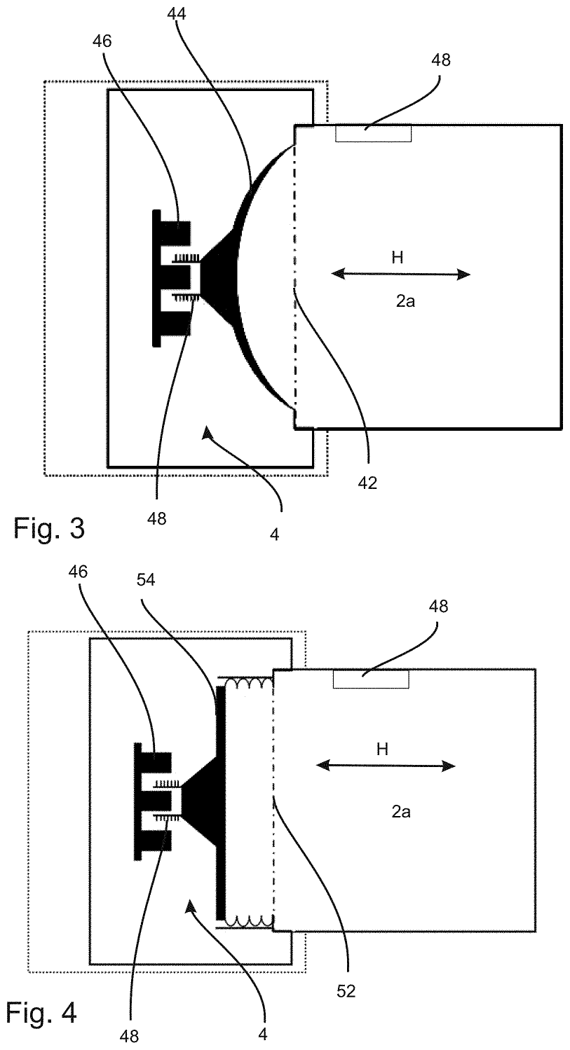

FIG. 3 shows a first illustration of a pressure fluctuation reduction device 4. Here, the reference sign 2a again refers to the reservoir or the annular channel. The reference sign 48 indicates a sensor device which is used to record pressure fluctuations and, in particular, to record them with a time dependency.

The reference sign 46 indicates a permanent magnet and the reference sign 48 indicates a coil. This is mechanically coupled to a vibrating part such as a diaphragm 1. By moving this diaphragm in the horizontal direction H, the volume of the reservoir 2a can be changed and can also be changed periodically, for example. In this way, pressure fluctuations inside the reservoir 2a can be compensated.

FIG. 4 shows a further design of a pressure fluctuation reduction device. Again, a permanent magnet 46 and a coil 48 are provided. The reference sign 54 here also indicates a vibrating element, such as a plate. Also by moving this plate in the horizontal direction H, the size of the reservoir 2a is changed and in this way pressure fluctuations can be counteracted.

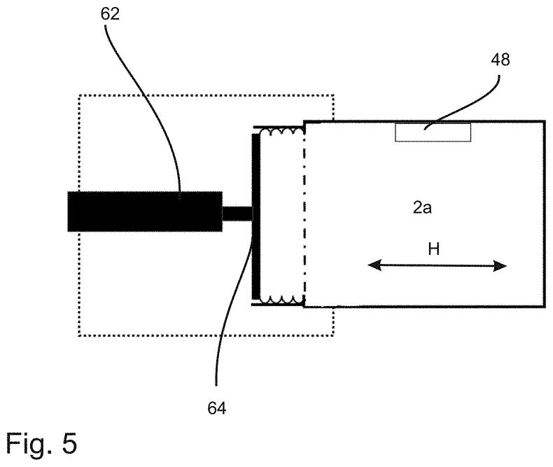

FIG. 5 shows a further embodiment of a pressure fluctuation reducing device 4. In this embodiment, the motor drive such as linear motor 62 is provided, to which in turn a plate 64 is attached, which is movable in the horizontal direction H to change the volume of the reservoir 2a.

Overall, pressure fluctuations within the reservoir can be compensated for in the way described.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognises that a certain feature described in a Fig. can also be advantageous without adopting further features from this Fig. Furthermore, the skilled person recognises that advantages can also result from a combination of several features shown in individual figures or in different figures.

1. An apparatus for forming plastic preforms into plastic containers, having at least one forming station configured to form the plastic preforms into the plastic containers by applying a flowable medium, wherein the forming station has an application device configured to apply the plastic preforms with the flowable medium, and at least one first pressure reservoir configured to store the flowable medium at a predetermined pressure,
wherein
the apparatus has a pressure fluctuation reducing device which is configured for reducing pressure fluctuations in the first pressure reservoir.

2. The apparatus according to claim 1,
wherein
the apparatus comprises at least a second pressure reservoir configured to store the flowable medium under a second predetermined pressure.

3. The apparatus according to claim 1,
wherein
the apparatus has a valve unit configured for the plastic preforms to be applied with different pressure stages of the flowable medium.

4. The apparatus according to claim 1,
wherein
an intake volume of the first pressure reservoir is variable.

5. The apparatus according to claim 1,
wherein
the apparatus comprises volume changing device configured to change the intake volume of the first pressure reservoir.

6. The apparatus according to claim 5,
wherein
the volume changing device comprises a membrane or a movable piston element.

7. The apparatus according to claim 5,
wherein
the volume changing device comprises a movement generating device.

8. The apparatus according to claim 1,
wherein
the apparatus comprises a sensor device configured to detect pressures within the reservoir.

9. The apparatus according to claim 8,
wherein
the apparatus comprises a control device which controls the volume dependence in dependence on the pressure values detected by the sensor means.

10. A method of forming plastic preforms into plastic containers, wherein the plastic preforms are formed into the plastic containers by the application of a flowable medium with at least one forming station using the apparatus having a forming station, a pressure reservoir and a pressure fluctuation reducing device as claimed in claim 1, the steps of:
applying the plastic preforms with the flowable medium and at least one first pressure reservoir which stores the flowable medium under a predetermined pressure, and
reducing pressure fluctuation using the reducing device to reduce pressure fluctuations in the first pressure reservoir.

11. The method according to claim 10,
wherein
the pressure fluctuations in the first pressure reservoir are reduced by volume changes of the first pressure reservoir.

12. The method according to claim 10,
wherein including the step of determining pressures within the reservoir using a sensor device.

13. The method according to claim 10,
wherein
the volume of the reservoir is changed periodically at least at times.

14. The method according to claim 12,
wherein
the intake volume is changed in dependence on the pressures detected by the sensor device.

15. The method according to claim 13,
wherein
the intake volume is changed in dependence on the pressures detected by the sensor device.
